(19) United States
(12) Patent Application Publication
(10) Pub. No.: US 2023/0137680 A1
(43) Pub. Date: May 4, 2023

(54) EXTERNAL ASYMMETRIC TORQUE MAGNETIC VALVE ACTUATOR

(71) Applicant: Edward P. Davis, Kihei, HI (US)

(72) Inventor: Edward P. Davis, Kihei, HI (US)

(21) Appl. No.: 17/916,630

(22) PCT Filed: Mar. 25, 2021
(86) PCT No.: PCT/US2021/024212

§ 371 Date: Oct. 3, 2022

Related U.S. Application Data
(60) Provisional application No. 63/004,622, filed on Apr. 3, 2020.

(51) Int. Cl. F16K 31/08; F16K 31/50

(52) U.S. Cl. CPC F16K 31/088; F16K 31/50; F16K 31/0668

(57) ABSTRACT

Various devices and techniques related to magnetically-actuated valves are generally described. In some examples, magnetically-actuated valves may include an asymmetric torque magnetic valve actuator effective to generate a first amount of torque when disposed in a first orientation and a second amount of torque when disposed in a second orientation. In some other examples, the valves may include mechanical stops that prevent binding of the valves in a closed or open position.

### CROSS REFERENCE TO RELATED APPLICATIONS

This application claims the benefit of U.S. Provisional Patent Application No. 63/004,622, filed Apr. 3, 2020, the disclosure of which is incorporated herein by reference in its entirety.

### FIELD

This application relates to valve technology and, more specifically, to valve actuator mechanisms.

### BACKGROUND

Valves often develop leaks as they age. Leaking valves can be annoying, wasteful, and can cause damage in residential settings, but can be far more problematic in industrial applications. Factory lines may need to be shut down to repack or replace valves, resulting in lost production and unnecessary downtime. Leaks can cause environmental damage and safety issues. Steam leaks can scald and even kill workers. The Environmental Protection Agency (EPA) is concerned about pollution resulting from leaky valve stem seals in factories and oil fields. In extreme cases, such as semiconductor manufacturing, even microscopic leaks can be fatal—breathing tanks and hazmat suits are often required to clean up after leaks are detected in semiconductor foundries.

### SUMMARY

Systems and methods are provided for magnet-actuated valves with asymmetric torque achieved by an external actuator device. For some applications, internal asymmetric actuation mechanisms may not be suitable in order to minimize entrained working fluid and/or due to concerns about corrosion (e.g., from caustic working fluids, etc.).

In accordance with various embodiments of the present invention, a valve assembly is generally described. In some examples, the valve assembly may comprise a ferromagnetic internal actuator. In some examples, the valve assembly may comprise an external actuator comprising at least one magnet. The external actuator may be arranged so that a first torque is transmitted to the ferromagnetic internal actuator when the external actuator is rotated in a first direction and a second torque, different from the first torque, may be transmitted to the ferromagnetic internal actuator when the external actuator is rotated in a second direction. In some examples, the valve assembly may further include a valve member effective to open and close a fluid flow path of the valve assembly. In yet other examples, the valve assembly may include a rotational stop feature coupled to a stem of the valve assembly or to the ferromagnetic internal actuator, wherein the rotational stop feature is arranged so as to contact a portion of the valve assembly to prevent further movement of the valve member in a first direction.

In accordance with embodiments of the present invention, another valve assembly is provided. The valve assembly may comprise a ferromagnetic internal actuator. The valve assembly may further include an external actuator comprising at least one magnet. In some examples, the external actuator may be arranged so that a first torque is transmitted to the ferromagnetic internal actuator when the external actuator is rotated in a first direction and a second torque, different from the first torque, may be transmitted to the ferromagnetic internal actuator when the external actuator is rotated in a second direction. In various examples, the valve assembly may include a valve member effective to open and close a fluid flow path of the valve assembly.

In some examples, the valve assembly may comprise an external actuator that includes a first element and a second element. In various examples, the first element may include a first magnet. In some examples, the second element may include a second magnet. In some examples, the first element and the second element may be coupled together such that the first element and the second element may rotate from an aligned orientation with respect to one another to an unaligned orientation with respect to one another. In some examples, a first torque may be transmitted to a ferromagnetic internal actuator of a valve when the external actuator is rotated in a first direction. In some further examples, a second torque, different from the first torque, may be transmitted to the ferromagnetic internal actuator when the external actuator is rotated in a second direction.

In various embodiments, the internal actuator comprises a ferromagnetic material, a permanent magnet, or an impermanently magnetic material (e.g., an impermanent magnet).

In some embodiments, the abutting surface comprises a substantially planar surface; and the recessed surface comprises a curved surface.

In some embodiments, the valve assembly further comprises a valve member effective to open and close a fluid flow path of the valve assembly; and a valve stem operatively coupled to the internal actuator and to the valve member.

In some embodiments, the valve assembly further comprises a pin or other physical protrusion coupled to the valve stem, wherein the pin or other physical protrusion is arranged so as to contact a portion of the valve assembly to prevent further movement of the valve member in the first direction.

Most traditional valves usually have two moving seals: (1) the seat (e.g., the seat seal) where the flow of material through the valve is allowed, controlled, and shut off, and (2) the stem seal that prevents the material (e.g., the material flowing through the valve) from leaking out of the hole for the stem and/or valve handle. Studies have shown that some high percentage of the leaks encountered in real world valves are associated with the stem seals because these seals tend to entrain dirt and grit which can erode the mating surfaces over time.

As such, many traditional valves face the problem of degrading and/or leaking stem seals over time. Previous seal-less valves often employed bending or flexing components such as bellows or membranes that can also degrade or fatigue leading to potential leaks in the long term. Additionally, previous generations of magnetic valves usually contained internal magnets and/or operated in a linear solenoid type manner making high temperature operation difficult to achieve (as magnets may permanently lose magnetization at high temperatures), and solenoids often require continuous power to maintain their position. Accordingly, in some examples described herein, magnetically-actuated valves are described which do not include internal permanent magnets. For example, an internal actuation member may be made from a ferromagnetic material (e.g., iron, an iron alloy, or some other material with ferromagnetic properties) such that the internal actuation member may be magnetized when exposed to a magnetic field of external magnets. Advantageously, the external magnets may be removed from such valves if the valve is to be subjected to high temperatures. This avoids the possible de-magnetization of the magnets. External magnets (e.g., in an external actuator) may be re-coupled to the valve after the high temperature application has been performed.

In some examples, magnetically-actuated valves may become stuck in either their open or closed positions (or both), especially after being over-tightened, over-loosened, having been left in one position for an extended period of time, and/or when handling sticky or corrosive substances. Magnetic valves may sometimes become stuck in a closed position due to friction of the seal, the duration of time that the valve has been closed, corrosion, properties of the substances flowing through the valve, and/or over-tightening the valve. For certain types of valves such as gate valves, globe valves, and butterfly valves, it may be desirable to limit the closing torque available from the magnetic valve coupling to protect the valve seat from over-tightening. However, in the event that the valve becomes stuck in the closed position, it may be desirable to have additional torque transmitting capability in the opening direction to release the valve from its stuck, closed position.

Magnetic valves often get stuck in the closed position simply because the maximum torque that can be transmitted by a traditional magnetic valve actuator is typically equal in both directions, and hence a component such as a valve gate cannot always be backed out of a position into which it was placed with maximum torque (especially if it has been in that position for a long period of time and there is corrosion or other degradation present). Other approaches to solving this problem such as return springs located in or around the valve seat may interfere with the fluid flow through the valve or catch debris that could interfere with the flow.

Some embodiments described herein prevent magnetic valves from becoming stuck in a particular position (typically the closed position) by providing higher torque handling capability in one rotary direction (usually the valve opening direction) relative to the other rotary direction (e.g., the valve closing direction). As previously described, providing higher torque handling capability in one direction relative to the other may offer improvements relative to other approaches such as springs that may interfere with the fluid flow characteristics of the valve especially when employed to prevent a valve from becoming stuck in the closed position. The various asymmetric torque magnetic valve actuators described herein may be located in the actuator portion of the valve away from the main path of fluid flow through the valve. The various asymmetric torque magnetic valve actuators described herein may be particularly useful for valves that close by pressing a moving actuator component against a fixed seat such as gate, globe, and/or butterfly valves, as these types of valves tend to be especially prone to becoming stuck in a closed or open position. Furthermore, the various asymmetric torque magnetic valve actuators described herein may offer improved reliability relative to previous solutions such as springs that flex, fatigue, and/or degrade over time.

Other embodiments of the various asymmetric torque magnetic valve actuators described herein may prevent magnetic valves from becoming stuck in a particular position (often the open position, sometimes both open and closed) by providing a positive rotational stop feature that prevents rotation in one direction past a specified position but allows free rotation in the other direction. Positive rotational stops (e.g., rotational stop features) described herein may be particularly useful for valves that open and close by position, such as ball and plug valves, and/or valves that open via clearing a moving actuator component from the path of the fluid flow such as gate, globe, and butterfly valves. By stopping rotation of the actuator in one direction past a specified rotational position, while allowing free rotation in the other, a valve can easily be adjusted to be fully open (or fully closed) while avoiding binding or stuck valve conditions. By providing this stop in the rotation of the actuator itself (rather than rotation or translation of an ancillary member), the possibility of binding (e.g., the valve becoming stuck in a position) is greatly reduced, and the ability to rotate freely in the other direction is maintained. In general, positive rotational stops can be employed in instances where a valve state is specified by position alone, such as, e.g., fully opened or closed ball or plug valves, or the fully opened position of a gate, globe, or butterfly valve. Asymmetric torque or force type mechanisms can be employed where a valve state (typically closed) is defined by a specified force against a valve seat such as for a fully closed gate or globe valve. Furthermore, because an asymmetric torque mechanism may have a preferential torque direction throughout the extent of valve mechanism travel, it may be desirable to stop rotation with a non-binding, positional type stop at the opposite end of travel.

For a valve containing a lead screw, such as a gate or globe valve or a travelling nut actuated ball valve, the various asymmetric torque magnetic valve actuators described herein may employ pins, nubs, or other mechanical features and/or physical protrusions to stop the rotation of the lead screw in the opposite (typically opening) rotational direction prior to the point that any component would become stuck. For example, in the case of a lead-screw driven gate valve, the asymmetric torque magnetic valve actuator may limit the closing torque to the specified value for the valve seat. Additional torque may be available in the opening direction in case the valve sticks, and two opposing pins (one on the lead screw or stem, the other on the gate) may stop the rotation of the lead screw relative to the gate prior to the lead-screw bottoming out in the gate (or the gate encountering any other object to potentially bind to), hence preventing the gate from becoming stuck in the open position. In various examples, the positive rotational stops may be referred to herein as “pin type rotational stops”, however, other shapes and/or features apart from pins may be used to instead impede the actuation of the valve beyond a particular point. Accordingly, use of the term “pin type rotational stop” describes one example embodiment of rotational stops, in accordance with various embodiments of the present disclosure.

As previously described, magnetic valves may sometimes become stuck in the closed position due to the torque limits inherent in their magnetic couplings if those limits are equal in both rotational directions (opening and closing).

The asymmetric torque magnetic valve actuators described herein may overcome this problem by allowing the torque capability of the magnetic coupling to be higher in one direction than the other. For example, the various asymmetric torque magnetic valve actuators described herein could be used to limit the closing torque on the valve to the recommended valve seating torque (in order to provide optimal valve seat life), but still be less than the torque available to open the valve, to reduce or eliminate the possibility that the valve will become stuck in the closed position. Additionally, in some embodiments, a pair of stops or pins that contact each other may be used to stop rotation of the lead screw once the valve reaches the fully opened valve position. Such stops or pins may reduce or eliminate the possibility that the valve becomes stuck in either position (closed or open).

The various asymmetric torque magnetic valve actuators described herein may help to prevent magnetic valves from becoming stuck, which is a potential problem for many magnetically-actuated valves. These various methods and actuators described herein may offer improvements over previous attempts to prevent valve sticking, such as use of springs. As previously described, springs may interfere with the fluid flow characteristics of the valve especially when employed to prevent a valve from becoming stuck in the closed position. Furthermore, springs may bend, flex, fatigue, and/or break over time.

Stuck valves require maintenance—often with the system shut down, which can reduce reliability and availability of the system. Valves that are prone to sticking often cannot be hermetically sealed, such as by welding, soldering, and/or brazing the valve cover shut, because of the necessity of being able to access the internal portions of the valve actuator in the event the valve becomes stuck. As previously described, return springs located in or around the valve seat may interfere with the fluid flow through the valve or catch debris that could interfere with the flow.

The various asymmetric torque magnetic valve actuators described herein may be used to produce high-reliability magnetic valves and may significantly reduce or eliminate sticking of valves in one or more of the open and closed positions.

Still other embodiments of the present disclosure will become readily apparent to those skilled in the art from the following detailed description. As will be realized, other and different embodiments from the specific examples provided herein are possible. The various details described herein are capable of modifications in various respects, according to the disclosure. As such, the drawings and detailed description are to be regarded as illustrative in nature and not as restrictive.

### BRIEF DESCRIPTION OF DRAWINGS

FIG. 1A depicts an assembled top view (along the axis of rotation) of a ferromagnetic magnet-actuated valve actuator effective to exhibit asymmetric torque, in accordance with some aspects of the present disclosure.

FIG. 1B depicts a top-down oblique view of a ferromagnetic magnet-actuated valve actuator effective to exhibit asymmetric torque, in accordance with some aspects of the present disclosure.

FIG. 2A depicts a top-down oblique view of a ferromagnetic magnet-actuated valve actuator that exhibits asymmetric torque, being actuated in the clockwise direction, in accordance with some aspects of the present disclosure.

FIG. 2B depicts a top-down oblique view of a ferromagnetic magnet-actuated valve actuator effective to exhibit asymmetric torque, being actuated in the counterclockwise direction, in accordance with some aspects of the present disclosure.

FIG. 3 depicts an assembled cross-sectional side view (perpendicular to the axis of rotation) of a magnet-actuated gate valve with a ferromagnetic actuator in its closed position that exhibits asymmetric torque, in accordance with some aspects of the present disclosure.

FIG. 4 depicts an assembled cross-sectional side view (perpendicular to the axis of rotation) of a magnet-actuated gate valve with a ferromagnetic actuator in its open position that exhibits asymmetric torque, in accordance with some aspects of the present disclosure.

FIG. 5 depicts an assembled cross-sectional side view (perpendicular to the axis of rotation) of a magnet-actuated gate valve with permanent magnets on both the internal and external actuators in its closed position that exhibits asymmetric torque, in accordance with some aspects of the present disclosure.

FIG. 6 depicts an assembled cross-sectional side view (perpendicular to the axis of rotation) of a magnet-actuated gate valve with permanent magnets on both the internal and external actuators in its open position that exhibits asymmetric torque, in accordance with some aspects of the present disclosure.

FIG. 7A depicts a top-down oblique view of an external magnet-actuated valve actuator that exhibits asymmetric torque, disposed in the reduced torque position, in accordance with some aspects of the present disclosure.

FIG. 7B depicts a bottom-up oblique view of an external magnet-actuated valve actuator that exhibits asymmetric torque, disposed in the bent lower torque position, in accordance with some aspects of the present disclosure.

FIG. 8 depicts a top-down oblique view of an external magnet-actuated valve actuator on its side that exhibits asymmetric torque, in its locked higher torque position, in accordance with some aspects of the present disclosure.

FIG. 9 depicts an assembled cross-sectional side view (perpendicular to the axis of rotation) of a magnet-actuated globe valve with a ferromagnetic actuator in its open position that exhibits asymmetric torque, in accordance with some aspects of the present disclosure.

FIG. 10 depicts an assembled cross-sectional side view (perpendicular to the axis of rotation) of a magnet-actuated globe valve with a ferromagnetic actuator in its closed position that exhibits asymmetric torque, in accordance with some aspects of the present disclosure.

### DETAILED DESCRIPTION

In the following description, reference is made to the accompanying drawings that illustrate several embodiments of the present disclosure. It is to be understood that other embodiments may be utilized and system or process changes may be made without departing from the spirit and scope of the present disclosure. The following detailed description is not to be taken in a limiting sense, and the scope of the embodiments of the present invention is defined only by the claims of the issued patent. It is to be understood that drawings are not necessarily drawn to scale.

Various embodiments of the present disclosure provide improved systems and methods for actuating valves using one or more asymmetric torque magnetic valve actuators as described herein. These embodiments may provide improved durability and leak-resistance and may prevent valves from sticking in an open and/or in a closed position. Additionally, the various asymmetric torque magnetic valve actuators described herein overcome various technical challenges presented when using conventional magnetic valves.

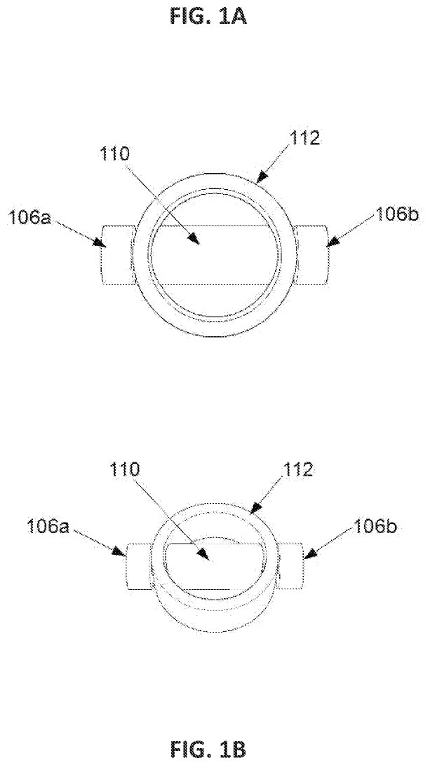

FIG. 1A depicts an assembled top view (along the axis of rotation) of a ferromagnetic magnet-actuated valve actuator effective to exhibit asymmetric torque, in accordance with some aspects of the present disclosure. The ferromagnetic magnet-actuated valve actuator depicted in FIG. 1A comprises an internal actuator (e.g., internal to the valve body) comprising actuator component 110 which may comprise a ferromagnetic material, such that magnetic flux is able to flow through the actuator component 110. External actuator components 106a and 106b may comprise permanent magnets (e.g., neodymium magnets), and may or may not move in unison depending on the direction of rotation. As depicted in FIG. 1A, actuator components 106a and 106b form a magnetic flux path through the interior of the valve (e.g., through actuator component 110) when in the high torque position depicted in FIG. 1A and described in further detail below. In at least some examples, actuator component 110 may be sealed inside an enclosure formed by a portion of the body of the valve 112 (e.g., the portion of the body of the valve 112 forms a cavity in which the actuator component 110 is disposed) and may therefore sometimes be referred to as an “internal actuator”. Actuator component 110 may be coupled to the stem of the valve such that rotating the actuator components 106a and 106b causes internal actuator component 110 to rotate which, in turn, may cause rotation of the stem. Rotation of the stem may be effective to open or close the valve, depending on the direction of rotation.

FIG. 1B depicts a top-down oblique view of the ferromagnetic magnet-actuated valve actuator of FIG. 1A, in accordance with some aspects of the present disclosure. The components in FIG. 1B that have previously been described with reference to FIG. 1A may not be described again for the purposes of clarity and brevity.

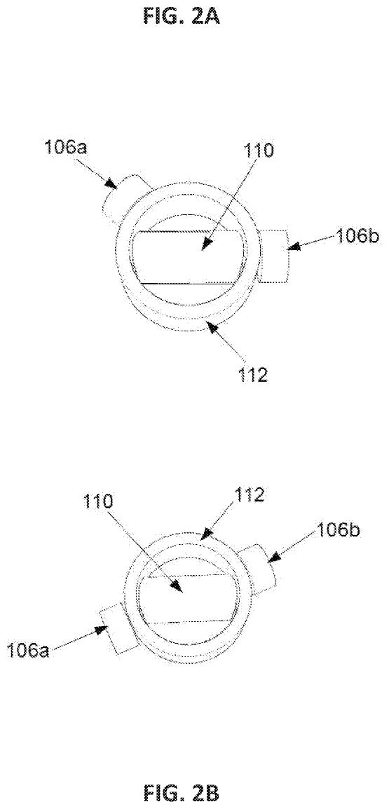

FIG. 2A depicts a top-down oblique view of a ferromagnetic magnet-actuated valve actuator that exhibits asymmetric torque, being actuated in the clockwise direction, in accordance with some aspects of the present disclosure. The components in FIG. 2A that have previously been described with reference to FIG. 1 may not be described again for purposes of clarity and brevity. In FIG. 2A, the external actuator may be attached to actuator components 106a and 106b, and may be rotated clockwise, against the drag torque of the valve on the internal actuator component 110. Because this actuator exhibits asymmetric torque, actuator component 106b follows actuator component 110 loosely, whereas actuator component 106a leads actuator component 110 in rotation generating a lower torque on the internal valve actuator component 110 than if actuator component 106a and actuator component 106b moved in unison.

FIG. 2B depicts a top-down oblique view of a ferromagnetic magnet-actuated valve actuator that could exhibit asymmetric torque, being actuated in the counterclockwise direction, in accordance with some aspects of the present disclosure. The components in FIG. 2B that have previously been described with reference to FIG. 1 and FIG. 2A may not be described again for the purposes of clarity and brevity. In FIG. 2B, the external actuator, attached to actuator components 106a and 106b, may be rotated counterclockwise, against the drag torque of the valve on the internal actuator component 110. Because this actuator exhibits asymmetric torque, and both actuator components 106a and 106b lead the internal actuator component 110 in rotation and a higher torque is generated on the internal valve actuator component 110 than if actuator component 106b loosely followed actuator component 110 as in FIG. 2A.

In the examples of FIGS. 2A and 2B, the external actuator is configured to deflect (with actuator components 106a and 106b becoming non-aligned) and provide lower torque when rotated in the clockwise direction and to maintain alignment of the actuator components 106a and 106b, and provide higher torque when rotated in the counterclockwise direction. In many valve actuation mechanisms, counterclockwise rotation of the actuator causes the valve to be opened and clockwise rotation of the actuator causes the valve to be closed. Accordingly, providing higher torque when opening the valve may be beneficial for releasing a valve from a stuck, closed position. Similarly, providing lower torque when closing a valve may prevent the valve actuator from being over-torqued and/or from becoming stuck. However, in other embodiments, the external actuator may instead deflect and provide lower torque when rotated in the counterclockwise direction and may be configured to remain aligned and provide higher torque when rotated in the clockwise direction, depending on the desired configuration.

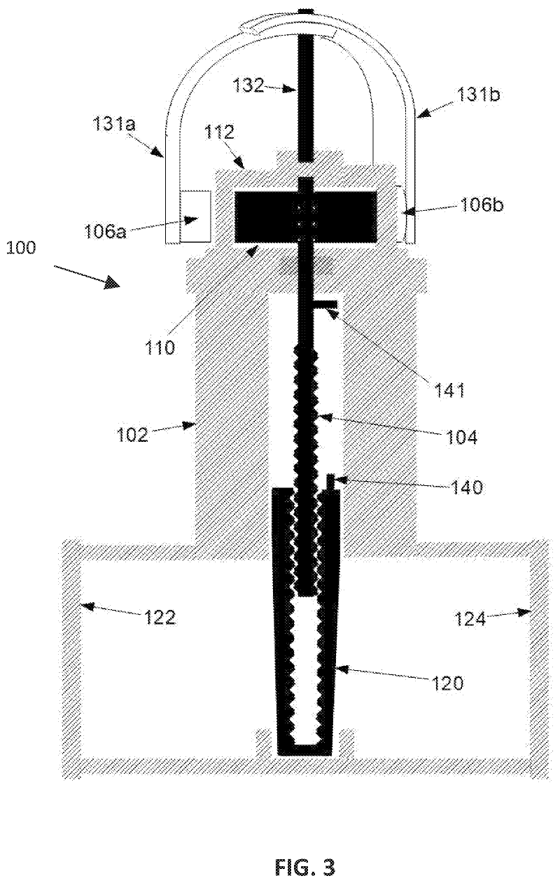

FIG. 3 depicts an assembled cross-sectional side view (perpendicular to the axis of rotation) of a magnet-actuated gate valve with a ferromagnetic internal actuator in its closed position that exhibits asymmetric torque, in accordance with some aspects of the present disclosure. The valve includes a body 102. In various examples, valve body 102 may be formed in such a way as to form an enclosure. In various examples, the internal actuator component 110 may be disposed within the enclosure. Valve body 102 may be the outer casing of valve 100 and may comprise any desired material depending on the desired application for the particular valve 100. In various examples, body 102 may comprise various metallic materials such as brass, copper, steel, bronze, gunmetal, alloy steels, non-400 series stainless steels, iron or the like. In some examples, body 102, or portions of body 102, may comprise a metal that has a low magnetic permeability. In some examples, portions of valve body 102 may comprise a material with a low magnetic permeability in order to avoid shunting magnetic flux through the body of the valve, thereby weakening the magnetic actuation mechanism described herein. In some examples, the portion of valve body 112 that forms a cavity or enclosure may comprise a metal that has a low magnetic permeability. For example, the metal may comprise, e.g., an Austenitic stainless steel (such as 300 series stainless), aluminum, copper, brass, titanium, and alloys thereof, and may exhibit a relative magnetic permeability (e.g., the ratio of magnetic permeability of a material vs. the magnetic permeability of free space) less than 10. In some embodiments, the metal may exhibit a relative magnetic permeability of about 1. In still other examples, body 102 may comprise one or more plastics and/or composite materials. Different materials may be selected for body 102 depending on the desired application for the valve 100. For example, materials may be selected for body 102 of valve 100 which are resistant to corrosion, heat, moisture, rust, and/or bacterial growth.

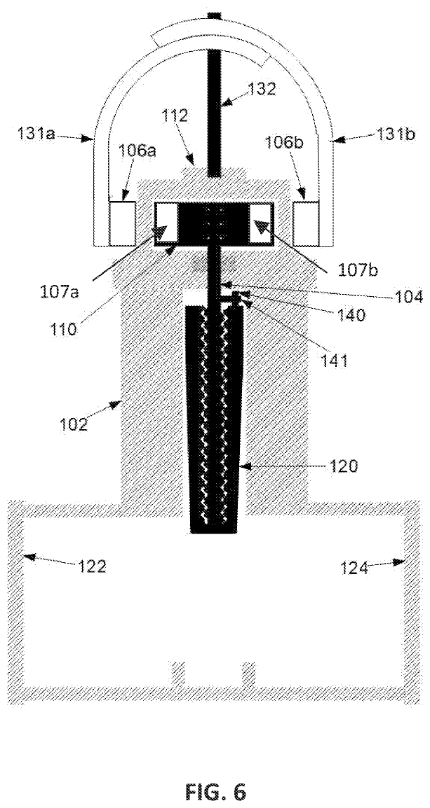

Valve 100 may include a stem 104. Stem 104 may transmit motion from a handle, actuator, and/or other controlling device (e.g., external actuator 130 of FIG. 6) to a movable valve member 120. For example, in a ball valve (e.g., a valve in which valve member 120 is a ball), stem 104 may be operatively coupled to the ball such that rotating the stem 104 using a handle or other actuator of the valve may, in turn, rotate the ball between an open position and a closed position to control a flow of fluid through a fluid flow path of the valve. Various types of valves along with their corresponding actuation mechanisms and valve members (sometimes referred to as “discs”) may be used in accordance with embodiments of the present disclosure. In a few examples, gate valves, ball valves, globe valves, butterfly valves, plug valves, poppet valves, needle valves, and/or spool valves may be used in accordance with embodiments of the present disclosure depending on the desired valve type. Generally, external actuator 130 depicted in FIG. 6 may comprise external actuator components 131a and 131b (depicted in FIG. 3, inter alia).

Body 102 of valve 100 may include a portion of the body of the valve 112 that defines an enclosure as depicted in FIG. 3. In some examples, the portion of the body of the valve 112 may have a smaller diameter and/or cross-sectional width relative to other portions of valve body 102. Additionally, in some examples, the portion of the body of the valve 112 may be relatively thin so as to transmit magnetic flux from external magnets 106a and 106b into the cavity formed by the portion of the body of the valve 112. As depicted, in some examples, internal actuator component 110 may be disposed within the cavity formed by the portion of the body of the valve 112 and may be operatively coupled to the portion of stem 104 that is disposed in the cavity. In various examples, the portions of body of the valve 112 adjacent to external magnets 106a and 106b may be of a thickness such that magnetic flux passes from an external magnet in external actuator component 106a, through internal actuator component 110, and to an external magnet in external actuator component 106b. In valve 100, stem 104 may be entirely contained within the body 102 of the valve 100 such that no portion of the stem 104 extends outside of body 102.

In some examples, the cavity or enclosure formed by the portion of the body of the valve 112 may be cylindrical. In various further examples, external actuator 130 may comprise an annular base portion concentric with a cylindrical portion of the body of the valve 112. External actuator components 106a, 106b may be disposed on a first portion of the annular base portion of external actuator 130. As previously described, external actuator 130 may comprise a ferromagnetic material to complete a magnetic circuit for magnetic flux flowing between external actuator components 106a, 106b through actuator component 110. A first magnetic pole section of external actuator components 106a may be disposed adjacent to a first location of the annular base portion of external actuator 130. Similarly, a second magnetic pole section of external actuator components 106b may be disposed adjacent to a second location of the annular base portion of external actuator 130.

Actuator component 110 may be located inside the enclosure or cavity formed by the portion of the body of the valve 112 and may be mechanically coupled to stem 104. Accordingly, rotation of actuator component 110 may rotate stem 104, which may, in turn, actuate movement of valve member 120 between an open position and a closed position in seat 118. As depicted in FIG. 3, actuator component 110 may be enclosed within the cavity formed by the portion of the body of the valve 112, such that actuator component 110 is not exposed to the exterior of body 102 of valve 100. In some examples, actuator component 110 may comprise a material having a high magnetic permeability such that magnetic flux flows from an external magnet (such as, for example, external actuator components 106a, 106b) through actuator component 110 and returns to either the same external magnet or a different external magnet. In some examples, actuator component 110 may comprise one or more ferromagnetic materials such as iron, nickel, cobalt and/or alloys thereof. In another example, actuator component 110 may comprise 400 series stainless steel. Although actuator component 110 may comprise one or more materials having high magnetic permeability, in various examples, actuator component 110 may not include permanent magnets (e.g., actuator component 110 may comprise an impermanently magnetic material). However, in various other examples, actuator component 110 may include one or more permanent magnets. In examples where actuator component 110 does not include permanent magnets, actuator component 110 and/or materials of actuator component 110 may be temporarily magnetized while actuator component 110 is exposed to magnetic fields of magnetic pole sections of external actuator components 106a, 106b.

In some examples, actuator component 110 may be non-radially symmetric. For example, as depicted in FIGS. 1A-2B, actuator component 110 may have a longitudinal axis (e.g., the horizontal length of the components as depicted in FIGS. 1A-2B) that is longer than a lateral axis (e.g., the vertical length of the components as depicted in FIGS. 1A-2B). For example, actuator component 110 may comprise an elongate actuator component with a first end aligned with a first magnetic pole section of external actuator component 106a and a second end aligned with a second magnetic pole section of actuator component 106b, in a preferred orientation. Additionally, in some examples, actuator component 110 may comprise a material of high magnetic permeability, such as iron or 400 series stainless steel, embedded within a material of low magnetic permeability, such as ceramic. In some examples, the embedded material may form a path within the ceramic material such that magnetic flux flows along the path when a magnetic field interacts with actuator component 110.

In some examples, external actuator components 131a and 131b may comprise a handle, lever, or other actuation mechanism effective to rotate external actuator components 106a, 106b around body 102. In various examples, motors may be used to turn the handle and/or control actuation of external actuator 130. Generally, when the handle is not being turned or otherwise actuated, the actuator component 110 may maintain its current position and thus the valve member 120 remains in its current state. Although external actuator components 131a and 131b are depicted in FIG. 3 as being above the valve body 102, in some examples, external actuator components 131a and 131b may be in-plane with external actuator components 106a, 106b or underneath external actuator components 106a, 106b. In some examples, external actuator components 131a and 131b may comprise a ferromagnetic material to form a return flow path for magnetic flux flowing from external magnet 106a, through actuator component 110, to external actuator component 106b, and through ferromagnetic external actuator components 131a and 131b to return to external actuator component 106a. It should be appreciated that in various other examples, magnetic flux may flow from external actuator component 106b, through actuator component 110, to external actuator component 106a, and through ferromagnetic external actuator components 131a and 131b to return to external actuator component 106b.

Magnetic flux from external actuator components 106a, 106b may be effective to orient actuator component 110 in a preferred orientation (e.g., aligned or deflected) with respect to the magnetic pole sections of external actuator components 106a, 106b.

In still other examples described in further detail below, external actuator component 106a may include a north pole section and south pole section. In such an example, magnetic flux may flow from the north pole section of external actuator component 106a, through a flux path in actuator component 110, and return from actuator component 110 to the south pole section of external actuator component 106a. Similarly, in another example, external actuator component 106b may include a north pole section and south pole section. In such an example, magnetic flux may flow from the north pole section of external actuator component 106b, through a flux path in actuator component 110 and return from actuator component 110 to the south pole section of external actuator component 106b.

External actuator components 106a and 106b may comprise, for example, permanent magnets such as Neodymium Iron Boron magnets, Samarium Cobalt magnets, Alnico magnets, Ceramic and/or Ferrite magnets. Examples of different Neodymium magnets may include N42, N52, and N42SH grade Neodymium magnets. Different magnets may exhibit different magnetic field strengths (in terms of Gauss and/or Tesla) and different pull forces. As such, different magnets may produce different amounts of torque in actuator component 110 when the magnets are rotated around the exterior of the portion of the body of the valve 112. In some examples, external actuator components 106a and/or 106b may comprise combinations of different permanent magnets. Additionally, in some examples, external actuator components 106a and/or 106b may comprise electromagnets.

By sealing stem 104 within body 102 of valve 100, a stem seal may be avoided. A stem seal is an interface through which a stem passes between the interior of a valve and the exterior of the valve. Dirt and/or other contaminants can be introduced at the stem seal and can cause a leak in the stem seal. The stem seal may differ in hardness or coefficient of thermal expansion from the surrounding materials, such as the stem, bonnet, and/or valve body, and hence may not seal consistently over time and over varying temperatures. As such, for many applications it may be advantageous to seal the stem within the body of the valve 100, as described herein.

Valve 100 may include ports 122 and 124. Although in the example depicted in FIG. 3, two ports are shown, more ports may be used depending on the particular valve. Ports 122 and 124 may be inlet and/or outlet ports. Additionally, in some examples, ports 122 and 124 may be interchangeable as inlet ports and outlet ports depending on the way valve 100 is installed in a system.

As described above, rotation of external actuator (and thus external actuator components 106a, 106b) may cause corresponding rotation of internal actuator component 110. Rotation of actuator component 110 may actuate stem 104 (depicted in FIG. 3) which may, in turn, actuate movement of valve member 120 between the open and closed position or between the closed and open position, depending on the direction of rotation of internal actuator component 110.

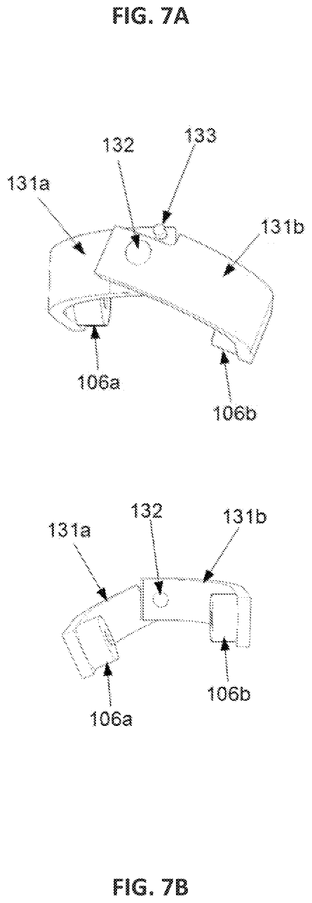

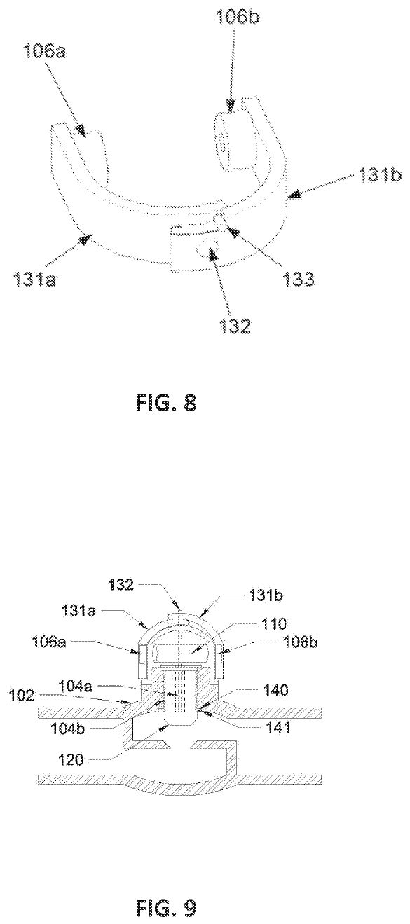

In the closed position shown in FIG. 3, torque and hence force available to press the gate against the valve seat in the closed position is limited by the asymmetric torque mechanism comprised of deflected actuator components 131a and 131b (see, e.g., FIG. 7A), but additional torque (e.g., +20%) may be available to break the gate free from the seat when opening the valve due to the aligned nature of the actuator components 131a and 131b (see, e.g., FIG. 8) hence preventing the valve from becoming stuck in a closed position.

In various examples, actuator component 110 may be attached to the inner stem 104. In various examples, actuator component 110 may be attached to the stem 104 with a pin. In various other examples, actuator component 110 may be fixed to stem 104 using a setscrew or shaped feature such as a square or hexagonal portion of a shaft of stem 104. In other examples, actuator component 110 may be press fit, welded, or adhered to stem 104. In yet other examples, stem 104 (or a portion thereof) and actuator component 110 may be formed from a single piece of metal.

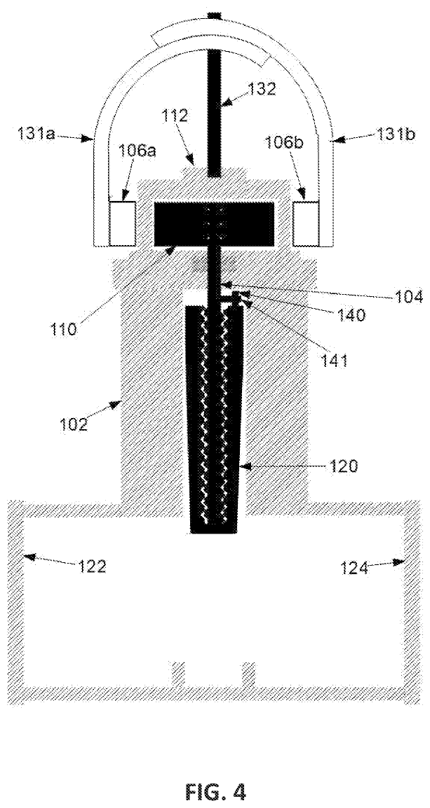

FIG. 4 depicts an assembled cross-sectional side view (perpendicular to the axis of rotation) of a magnet-actuated gate valve with a ferromagnetic internal actuator similar to that shown in FIG. 3 but in its open position. The ferromagnetic internal actuator architecture in FIG. 4 exhibits asymmetric torque, in accordance with some aspects of the present disclosure. Those components of FIG. 4 that have been previously discussed in reference to FIGS. 1-3 may not be discussed again herein for purposes of clarity and brevity. Due to the aligned nature of the actuator components 131a and 131b in FIG. 4 (see, e.g., FIG. 8) additional torque is available when opening the valve to prevent it from becoming stuck in a closed position. Actuator components 131a and 131b may be referred to as “external” actuator components since they are disposed on the exterior of the valve body 102.

In the open valve position depicted in FIG. 4, the pin type rotational position stops 140, 141 (e.g., rotational stop features) serve to stop rotation in the counterclockwise direction past the point where the valve is full open preventing the valve from being stuck in the open position due to the valve gate contacting some portion of the interior of body 102 of the valve or the threads on stem 104 bottoming out in valve member 120 (e.g., a gate of a gate valve). However, the rotational position stops 140, 141 allow actuation in the reverse direction (e.g., the clockwise direction) allowing the valve to be closed again.

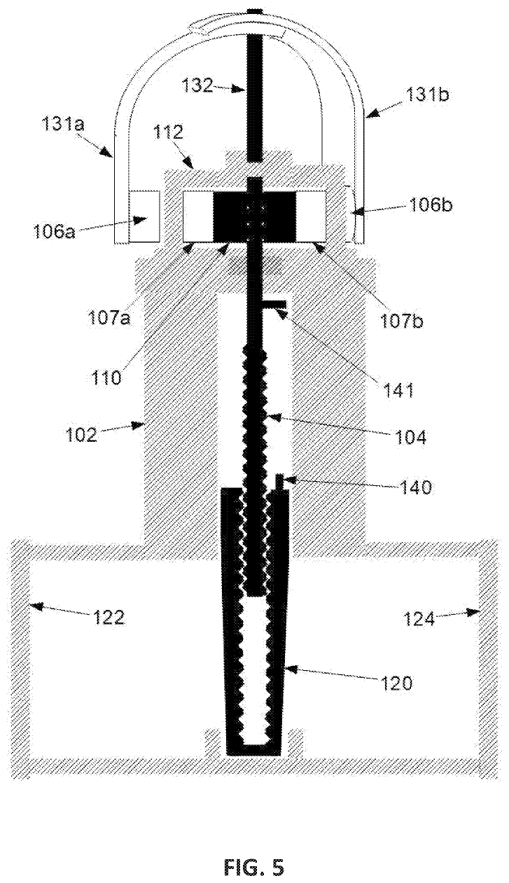

FIG. 5 depicts an assembled cross-sectional side view (perpendicular to the axis of rotation) of a magnet-actuated gate valve effective to exhibit asymmetric torque, in accordance with some aspects of the present disclosure. In FIG. 5, actuator component 110 includes internal permanent magnets 107a, 107b. Those components of FIG. 5 that have been previously discussed in reference to FIGS. 1-4 may not be discussed again herein for purposes of clarity and brevity. In the closed position shown in FIG. 5, torque and hence force available to press the gate against the valve seat is limited by the asymmetric torque mechanism comprised of deflected actuator components 131a and 131b (see, e.g., FIG. 2A), but additional torque (e.g., +20%) may be available to break the gate free from the seat when opening the valve due to the aligned nature of the external actuator components 131a, 131b (see, e.g., FIG. 2B) hence preventing the valve from becoming stuck in a closed position.

FIG. 6 depicts an assembled cross-sectional side view (perpendicular to the axis of rotation) of a magnet-actuated gate valve effective to exhibit asymmetric torque, in accordance with some aspects of the present disclosure. In FIG. 6, actuator component 110 includes internal permanent magnets 107a, 107b. Those components of FIG. 6 that have been previously discussed in reference to FIGS. 1-5 may not be discussed again herein for purposes of clarity and brevity. In the open position shown in FIG. 6, additional torque (e.g., +20%) may be available to break the gate free from the seat when opening the valve due to the aligned nature of the external actuator components 131a, 131b (see, e.g., FIG. 2B) hence preventing the valve from becoming stuck in a closed position. In this open position, the pin type rotational position stops 140, 141 serve to stop rotation in the counterclockwise direction past the point where the valve is full open preventing the valve from being stuck in the open position due to the valve gate contacting some portion of the interior of body 102 of the valve or the threads on stem 104 bottoming out in gate 120. However, the rotational position stops 140, 141 allow actuation in the reverse direction (e.g., the clockwise direction) allowing the valve to be closed again.

FIG. 7A depicts a top-down oblique view of an external magnet-actuated valve actuator that exhibits asymmetric torque, disposed in the reduced torque position, in accordance with some aspects of the present disclosure. Those components of FIG. 7A that have been previously discussed in reference to FIGS. 1-6 may not be discussed again herein for purposes of clarity and brevity. FIG. 7A. shows the external portion of the external actuator components 131a and 131b in a misaligned, unlocked configuration. In the example depicted in FIG. 7A, when the actuation mechanism is actuated in the clockwise direction, external actuator components 131a and 131b deflect and are held in a misaligned, bent orientation. Only one of the external actuator components 131a, 131b transmits maximal torque to the valve mechanism (e.g., to rotating the internal actuator 110 and ultimately stem 104 of the gate valve depicted in FIGS. 4-6). External actuator component 131a may be considered a first element of the external actuator and external actuator component 131b may be considered a second element of the external actuator. The first element (e.g., external actuator component 131a) and the second element (e.g., external actuator component 131b) may be coupled together using an element 132 (e.g., a pin) and may both rotate independently around an axis of the element 132. Accordingly, the first element (e.g., external actuator component 131a) and second element (e.g., external actuator component 131b) of the external actuator may be coupled together in a hinged relationship using element 132. The first element and second element may be sized, shaped, and coupled to one another so as to deflect from an aligned orientation (e.g., FIG. 2B) to an unaligned orientation (FIG. 2A, FIGS. 7A, 7B). For example, external actuator component 131a (e.g., the first element of the external actuator) may be held in place and external actuator component 131b (e.g., the second element of the external actuator) may be rotated in a clockwise direction (see FIG. 7A) until the feature 133 prevents further rotation. As previously described, when the external actuator is used to close a magnetic valve comprising an internal actuator component 110 (e.g., a ferromagnetic actuator component) by rotating the external actuator in the clockwise direction, the first element and the second element may deflect from an aligned orientation to an unaligned orientation with respect to one another and a lower amount of torque may be applied to close the valve. Conversely, when the external actuator is used to open a magnetic valve comprising an internal actuator component 110 (e.g., a ferromagnetic actuator component) by rotating the external actuator in the counterclockwise direction, the first element and the second element may remain in the aligned orientation with respect to one another. For example, the feature 133 may be effective to prevent rotation of the first element and/or the second element past the aligned orientation and may thus “hold” the first element and the second element in the aligned orientation with respect to one another when the external actuator is rotated counterclockwise. When the external actuator is rotated counterclockwise with the first element and the second element in the aligned orientation with respect to one another, a higher amount of torque (relative to the amount of torque applied when the first and second element are rotated clockwise in the unaligned orientation) may be applied to open the valve.

FIG. 7B depicts a bottom-up oblique view of an external magnet-actuated valve actuator that exhibits asymmetric torque, disposed in the bent lower torque position, in accordance with some aspects of the present disclosure. Those components of FIG. 7B that have been previously discussed in reference to FIGS. 1-6 may not be discussed again herein for purposes of clarity and brevity. FIGS. 7A and 7B show the external portion of the external actuator components 131a and 131b in a misaligned, unlocked configuration. In the example depicted in FIGS. 7A and 7B, when the actuation mechanism is actuated in the clockwise direction, external actuator components 131a and 131b deflect and are held in a misaligned, bent orientation, and only one of the external actuator components 131a, 131b transmits maximal torque to the valve mechanism (e.g., to rotating the internal actuator component 110 and ultimately stem 104 of the gate valve depicted in FIGS. 4-6).

FIG. 8 depicts a top-down oblique view of an external magnet-actuated valve actuator on its side that exhibits asymmetric torque, in its locked higher torque position, in accordance with some aspects of the present disclosure. FIG. 8 shows the external portion of the external actuator components 131a and 131b in an aligned, locked configuration. In the example depicted in FIG. 8, when actuator component 131a is actuated in the counterclockwise direction, external actuator components 131a and 131b are held in an aligned, straightened orientation by feature 133 (e.g., a pin, ridge, protrusion, and/or other physical feature of external actuator component 131a and/or 131b that prevents further rotation in one direction (counterclockwise or clockwise) to hold the external actuator components 131a, 131b in an aligned orientation with respect to one another). In the example of FIG. 7A, external actuator component 131b may rotate around element 132 in the clockwise direction until prevented from further rotation by feature 133 (e.g., at 90° or some other desired angle of deflection between external actuator component 131a and external actuator component 131b). Conversely, when the external actuator is rotated in the counterclockwise direction, feature 133 may maintain external actuator component 131a and external actuator component 131b in an aligned orientation with respect to one another. In various examples, when actuator component 131a is actuated in the counterclockwise direction, external actuator components 131a and 131b are held in an aligned, straightened orientation by feature 133 and both actuator components 106a and 106b may transmit torque to the valve mechanism (e.g., to rotating the internal actuator component 110 and ultimately stem 104 of the gate valve depicted in FIGS. 4-6).

FIG. 9 depicts an assembled cross-sectional side view (perpendicular to the axis of rotation) of a magnet-actuated globe valve with a ferromagnetic internal actuator in its open position (full counterclockwise position of the movable valve actuator component), that exhibits asymmetric torque, in accordance with some aspects of the present disclosure. Additionally, the globe valve depicted in FIG. 9 comprises pin type rotational position stops 140, 141 in the opening direction, in accordance with some aspects of the present disclosure. Those components of FIG. 9 previously described with reference to FIGS. 1-8 may not be described herein for purposes of brevity and clarity. In the open position, pin type rotational position stops 140 and 141 serve to stop rotation in the counterclockwise direction past the point where the valve is fully open, but allow actuation to reverse to close the valve again.

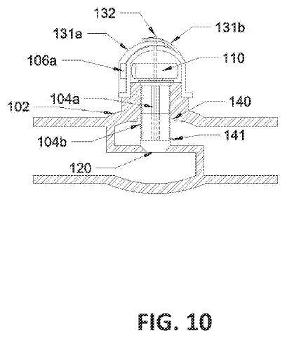

FIG. 10 depicts an assembled cross-sectional side view (perpendicular to the axis of rotation) of a magnet-actuated globe valve of FIG. 9 with a ferromagnetic internal actuator in its closed position including external actuator components 131a and 131b that exhibits asymmetric torque, in accordance with some aspects of the present disclosure. Those components of FIG. 10 previously described with reference to FIGS. 1-9 may not be described herein for purposes of brevity and clarity. In the closed position depicted in FIG. 10, torque and hence force available to press the globe against the valve seat is limited by the asymmetric torque mechanism comprised of external actuator components 131a and 131b, but additional torque (typically 20% more) is available to break the globe free from the seat in order to open the valve hence preventing it from becoming stuck.

Among other potential benefits, valves in accordance with embodiments of the present disclosure may alleviate the problem of valves becoming stuck in an open or closed position due to corrosion or build-up of materials on and/or in the valve. As previously described, the asymmetric torque magnetic valve actuators described herein may be effective to generate higher torque when opening the valve and reduced torque when closing the valve. Additionally, various rotational stops are described that may mechanically prevent the valves from being closed or open past a specific point. Use of such rotational stops may prevent the valve member from binding with the valve seat and/or with an interior portion of the valve body. Accordingly, the various embodiments described herein offer technological improvements over previous valve actuators and over magnetic valve actuators in particular.

Aspects of the subject matter described herein may be useful alone or in combination with one or more other aspects described herein. In a 1st example aspect of the present disclosure, a valve assembly comprises a ferromagnetic internal actuator, an external actuator comprising at least one magnet, wherein the external actuator is arranged so that a first torque is transmitted to the ferromagnetic internal actuator when the external actuator is rotated in a first direction (e.g., clockwise or counterclockwise) and a second torque, different from the first torque, is transmitted to the ferromagnetic internal actuator when the external actuator is rotated in a second direction (e.g., clockwise or counterclockwise), a valve member effective to open and close a fluid flow path of the valve assembly; and a rotational stop feature coupled to a stem of the valve assembly or to the ferromagnetic internal actuator, wherein the rotational stop feature is arranged so as to contact a portion of the valve assembly preventing further movement of the valve member when the external actuator is rotated in the second direction.

In accordance with a 2nd example aspect of the present disclosure, which may be used in combination with any one or more of other aspects described herein (e.g., the 1st aspect), wherein the first torque is less than the second torque.

In accordance with a 3rd example aspect of the present disclosure, which may be used in combination with any one or more of other aspects described herein (e.g., the 1st aspect), wherein the ferromagnetic internal actuator comprises an impermanent magnet.

In accordance with a 4th example aspect of the present disclosure, which may be used in combination with any one or more of other aspects described herein (e.g., the 1st aspect), wherein the external actuator comprises a first element and a second element coupled together and configured to rotate independently around an axis during actuation of the valve assembly.

In accordance with a 5th example aspect of the present disclosure, which may be used in combination with any one or more of other aspects described herein (e.g., the 4th aspect), wherein the first element and the second element are configured to maintain an aligned orientation with respect to one another when the external actuator is rotated in the second direction.

In accordance with a 6th example aspect of the present disclosure, which may be used in combination with any one or more of other aspects described herein (e.g., the 5th aspect), wherein the first element and second element are configured to deflect from an aligned orientation to an unaligned orientation when the external actuator is rotated in the first direction.

In accordance with a 7th example aspect of the present disclosure, which may be used in combination with any one or more of other aspects described herein (e.g., the 1st aspect), wherein the first torque is transmitted from the ferromagnetic internal actuator to the stem of the valve assembly when the external actuator is rotated in the first direction.

In accordance with an 8th example aspect of the present disclosure, which may be used in combination with any one or more of other aspects described herein (e.g., the 1st aspect), wherein the second torque is transmitted from the ferromagnetic internal actuator to the stem of the valve assembly when the external actuator is rotated in the second direction.

In a 9th example aspect of the present disclosure, a valve assembly comprises a ferromagnetic internal actuator; an external actuator comprising at least one magnet, wherein the external actuator is arranged so that a first torque is transmitted to the ferromagnetic internal actuator when the external actuator is rotated in a first direction and a second torque, different from the first torque, is transmitted to the ferromagnetic internal actuator when the external actuator is rotated in a second direction; and a valve member effective to open and close a fluid flow path of the valve assembly.

In accordance with a 10th example aspect of the present disclosure, which may be used in combination with any one or more of other aspects described herein (e.g., the 9th aspect), the valve assembly further comprising a rotational stop feature coupled to a stem of the valve assembly or to the ferromagnetic internal actuator, wherein the rotational stop feature is arranged so as to contact a portion of the valve assembly preventing further movement of the valve member during rotation of the external actuator in the second direction.

In accordance with a 11th example aspect of the present disclosure, which may be used in combination with any one or more of other aspects described herein (e.g., the 9th aspect), wherein the first torque is less than the second torque.

In accordance with a 12th example aspect of the present disclosure, which may be used in combination with any one or more of other aspects described herein (e.g., the 9th aspect), wherein the ferromagnetic internal actuator comprises an impermanent magnet.

In accordance with a 13th example aspect of the present disclosure, which may be used in combination with any one or more of other aspects described herein (e.g., the 9th aspect), wherein the external actuator comprises a first element and a second element coupled together and configured to rotate independently around an axis during actuation of the valve assembly.

In accordance with a 14th example aspect of the present disclosure, which may be used in combination with any one or more of other aspects described herein (e.g., the 13th aspect), wherein the first element and the second element are configured to maintain an aligned orientation with respect to one another when the external actuator is rotated in the second direction.

In accordance with a 15th example aspect of the present disclosure, which may be used in combination with any one or more of other aspects described herein (e.g., the 14th aspect), wherein the first element and second element are configured to deflect from the aligned orientation to an unaligned orientation when the external actuator is rotated in the first direction.

In accordance with a 16th example aspect of the present disclosure, which may be used in combination with any one or more of other aspects described herein (e.g., the 14th aspect), wherein the external actuator comprises a feature preventing the first element from rotating past the aligned orientation when the external actuator is rotated in the second direction.

In a 17th example aspect of the present disclosure, a valve assembly comprises an external actuator comprising: a first element comprising a first magnet; and a second element comprising a second magnet, the first element and the second element being coupled together such that the first element and the second element rotate from an aligned orientation with respect to one another to an unaligned orientation with respect to one another, wherein a first torque is transmitted to a ferromagnetic internal actuator of a valve when the external actuator is rotated in a first direction and a second torque, different from the first torque, is transmitted to the ferromagnetic internal actuator when the external actuator is rotated in a second direction.

In accordance with a 18th example aspect of the present disclosure, which may be used in combination with any one or more of other aspects described herein (e.g., the 17th aspect), wherein the first torque is less than the second torque.

In accordance with a 19th example aspect of the present disclosure, which may be used in combination with any one or more of other aspects described herein (e.g., the 17th aspect), wherein the ferromagnetic internal actuator comprises an impermanent magnet.

In accordance with a 20th example aspect of the present disclosure, which may be used in combination with any one or more of other aspects described herein (e.g., the 17th aspect), the first element and second element are configured to maintain the aligned orientation with respect to one another when the external actuator is rotated in the second direction; and the first element and second element are configured to maintain the unaligned orientation with respect to one another when the external actuator is rotated in the first direction.

While the invention has been described in terms of particular embodiments and illustrative figures, those of ordinary skill in the art will recognize that the invention is not limited to the embodiments or figures described.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one,” “at least one” or “one or more.” Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

The description of embodiments of the disclosure is not intended to be exhaustive or to limit the disclosure to the precise form disclosed. While specific embodiments and examples for the disclosure are described herein for illustrative purposes, various equivalent modifications are possible within the scope of the disclosure, as those skilled in the relevant art will recognize. Such modifications may include, but are not limited to, changes in the dimensions and/or the materials shown in the disclosed embodiments.

Specific elements of any embodiments can be combined or substituted for elements in other embodiments. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Therefore, it should be understood that the invention can be practiced with modification and alteration within the spirit and scope of the appended claims. The description is not intended to be exhaustive or to limit the invention to the precise form disclosed. It should be understood that the invention can be practiced with modification and alteration and that the invention be limited only by the claims and the equivalents thereof.

What is claimed is:

1. A valve assembly, comprising:
a ferromagnetic internal actuator;
an external actuator comprising at least one magnet, wherein the external actuator is arranged so that a first torque is transmitted to the ferromagnetic internal actuator when the external actuator is rotated in a first direction and a second torque, different from the first torque, is transmitted to the ferromagnetic internal actuator when the external actuator is rotated in a second direction;
a valve member effective to open and close a fluid flow path of the valve assembly; and
a rotational stop feature coupled to a stem of the valve assembly or to the ferromagnetic internal actuator, wherein the rotational stop feature is arranged so as to contact a portion of the valve assembly preventing further movement of the valve member when the external actuator is rotated in the second direction.

2. The valve assembly of claim 1, wherein the first torque is less than the second torque.

3. The valve assembly of claim 1, wherein the ferromagnetic internal actuator comprises an impermanent magnet.

4. The valve assembly of claim 1, wherein the external actuator comprises a first element and a second element coupled together and configured to rotate independently around an axis during actuation of the valve assembly.

5. The valve assembly of claim 4, wherein the first element and the second element are configured to maintain an aligned orientation with respect to one another when the external actuator is rotated in the second direction.

6. The valve assembly of claim 5, wherein the first element and second element are configured to deflect from an aligned orientation to an unaligned orientation when the external actuator is rotated in the first direction.

7. The valve assembly of claim 1, wherein the first torque is transmitted from the ferromagnetic internal actuator to the stem of the valve assembly when the external actuator is rotated in the first direction.

8. The valve assembly of claim 1, wherein the second torque is transmitted from the ferromagnetic internal actuator to the stem of the valve assembly when the external actuator is rotated in the second direction.

9. A valve assembly, comprising:
a ferromagnetic internal actuator;
an external actuator comprising at least one magnet, wherein the external actuator is arranged so that a first torque is transmitted to the ferromagnetic internal actuator when the external actuator is rotated in a first direction and a second torque, different from the first torque, is transmitted to the ferromagnetic internal actuator when the external actuator is rotated in a second direction; and
a valve member effective to open and close a fluid flow path of the valve assembly.

10. The valve assembly of claim 9, further comprising a rotational stop feature coupled to a stem of the valve assembly or to the ferromagnetic internal actuator, wherein the rotational stop feature is arranged so as to contact a portion of the valve assembly preventing further movement of the valve member during rotation of the external actuator in the second direction.

11. The valve assembly of claim 9, wherein the first torque is less than the second torque.

12. The valve assembly of claim 9, wherein the ferromagnetic internal actuator comprises an impermanent magnet.

13. The valve assembly of claim 9, wherein the external actuator comprises a first element and a second element coupled together and configured to rotate independently around an axis during actuation of the valve assembly.

14. The valve assembly of claim 13, wherein the first element and the second element are configured to maintain an aligned orientation with respect to one another when the external actuator is rotated in the second direction.

15. The valve assembly of claim 14, wherein the first element and second element are configured to deflect from the aligned orientation to an unaligned orientation when the external actuator is rotated in the first direction.

16. The valve assembly of claim 14, wherein the external actuator comprises a feature preventing the first element from rotating past the aligned orientation when the external actuator is rotated in the second direction.

17. A valve assembly comprising:
an external actuator comprising:
a first element comprising a first magnet; and
a second element comprising a second magnet, the first element and the second element being coupled together such that the first element and the second element rotate from an aligned orientation with respect to one another to an unaligned orientation with respect to one another, wherein a first torque is transmitted to a ferromagnetic internal actuator of a valve when the external actuator is rotated in a first direction and a second torque, different from the first torque, is transmitted to the ferromagnetic internal actuator when the external actuator is rotated in a second direction.

18. The valve assembly of claim 17, wherein the first torque is less than the second torque.

19. The valve assembly of claim 17, wherein the ferromagnetic internal actuator comprises an impermanent magnet.

20. The valve assembly of claim 17, wherein:
the first element and second element are configured to maintain the aligned orientation with respect to one another when the external actuator is rotated in the second direction; and
the first element and second element are configured to maintain the unaligned orientation with respect to one another when the external actuator is rotated in the first direction.
